(19) United States
(12) Patent Application Publication
(10) Pub. No.: US 2008/0111806 A1
(43) Pub. Date: May 15, 2008

(54) Paperstock Card Having a Printed Dynamic Display Method and Apparatus

(75) Inventors: Gabriela A. Dyrc, Hoffman Estates, IL (US); Hakeem B. Adewole, Schaumburg, IL (US); Paul W. Brazis, South Elgin, IL (US); Katherine M. Devanie, Glendale Heights, IL (US)

Correspondence Address: MOTOROLA/FETF, 120 S. LASALLE STREET, SUITE 1600, CHICAGO, IL, 60603-3406, US

(73) Assignee: MOTOROLA, INC., Schaumburg, IL (US)

(21) Appl. No.: 11/558,695

(22) Filed: Nov. 10, 2006

(51) Int. Cl. G06F 3/038; G09G 3/20; G06Q 20/00

(52) U.S. Cl. 345/211; 345/55; 705/16

(57) ABSTRACT

A paperstock card (201) is integrally combined (102) with each of a printed dynamic display (203), a printed display control circuit (202), and a printed power source (204). So configured, the paperstock card can offer, in a relatively economical and flexible manner, textual and/or image-based content of choice. In addition, by this approach, some or all of this content can comprise animated content. By one approach, for example, this could even comprise video content depicting the person who presents the paperstock card to a given recipient.

### TECHNICAL FIELD

This invention relates generally to the printing of electric circuitry on paper.

### BACKGROUND

Paperstock cards, such as greeting cards and postcards, are known in the art. Such paperstock cards traditionally comprise printed still images and text. In some cases, lenticular lenses are employed to provide images that vary with respect to the viewing angle of the observer. Non-functional graphic arts inks are usually used for such purposes. For the most part, such paperstock cards are static entities and can only be changed by invasive editing (for example, by handwriting additional content on the card, by crossing out or otherwise occluding original content on the paperstock card, and so forth).

In many cases, such limited alteration capability leads to dissatisfaction. The fixed content on such a paperstock card may express an incomplete or even an inappropriate sentiment for a given prospective user of that paperstock card. Similarly, the invasive editing that may be required to correct the substantive content may itself yield a composite result that, again, constitutes an unacceptable result for such a user.

As an attempt to redress such concerns, one prior art approach provides an opportunity for a given purchaser of such a paperstock card to customize the paperstock card prior to printing the static images that will comprise the finished product. This opportunity may be remotely provided (as when the user gains access to the customization process via the Internet) or may be provided at or near a point of purchase (as when an in-store kiosk provides a user interface to facilitate receiving customization instructions from such a purchaser prior to printing the paperstock card).

While satisfactory to a point, such solutions nevertheless often continue to frustrate at least some users with respect to the relative paucity of customization opportunities available through such processes.

### BRIEF DESCRIPTION OF THE DRAWINGS

The above needs are at least partially met through provision of the paperstock card having a printed dynamic display method and apparatus described in the following detailed description, particularly when studied in conjunction with the drawings, wherein:

FIG. 1 comprises a flow diagram as configured in accordance with various embodiments of the invention; and

FIG. 2 comprises a block diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a paperstock card is integrally combined with each of a printed dynamic display, a printed display control circuit, and a printed power source. So configured, the paperstock card can offer, in a relatively economical and flexible manner, textual and/or image-based content of choice. In addition, by this approach, some or all of this content can comprise animated content. By one approach, for example, this could even comprise video content depicting the person who presents the paperstock card to a given recipient.

These teachings are highly flexible and readily scaled as desired. If desired, such a paperstock card can be further integrally combined with a memory. Such a memory can contain some or all of the aforementioned displayable content. By one approach, a user interface (which is either integrally formed with the paperstock card or that comprises an external component) can serve to facilitate the entry of customized content into that memory. These teachings will also facilitate the integral provision of one or more sensors and/or audio transducers with the paperstock card to thereby permit the display of content to be rendered, partially or fully, dependent and/or interactive with respect to one or more sensed inputs or conditions and/or to accompany display content with synchronized or unsynchronized audio content.

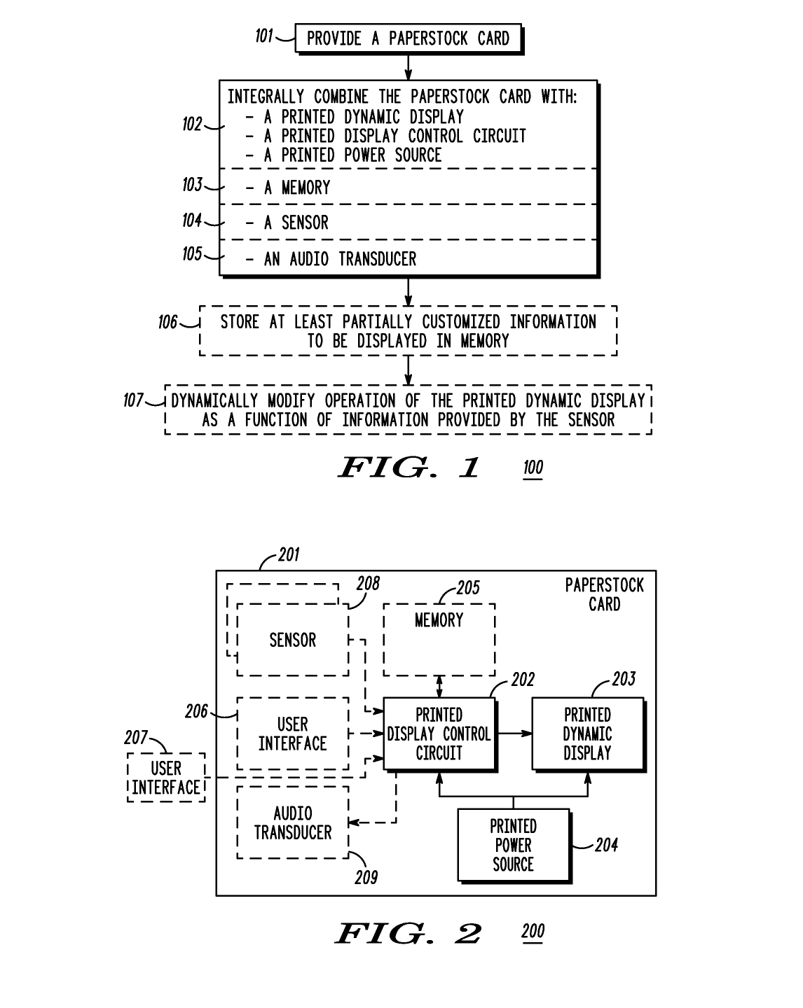

These and other benefits may become clearer upon making a thorough review and study of the following detailed description. Referring now to the drawings, and in particular to FIG. 1, an illustrative exemplary process 100 provides for provision 101 of a paperstock card. This paperstock card can comprise, for example, a greeting card, a postcard, and so forth. As used herein, the term paperstock will be understood to refer to such things as paper of various kinds, weights, colors, coatings, and sizes, cardboard (including corrugated cardboard), and the like. This paperstock card can comprise an unfolded planar object (such as a postcard) or can be folded once or more times (such as a greeting card) as desired.

This process 100 then provides for integrally combining 102 this paperstock card with a printed dynamic display, a printed display control circuit that operably couples to the printed dynamic display, and a printed power source that operably couples to both the printed dynamic display and the printed display control circuit. Printing techniques and materials in this regard are known in the art and require no further elaboration here. So configured, the printed dynamic display can display one or more images of choice as per the instructions and/or control of the printed display control circuit. Such images can comprise still images of choice or can be partially or fully animated. Similarly, such images can comprise monochromatic images or can comprise, in part or in full, full color images depending upon the display technology utilized and/or the needs and requirements of a given application setting.

By one approach, this process 100 can optionally further comprise integrally combining 103 this paperstock card with a memory. By one approach this memory operably couples to the printed display control circuit. So configured, this memory can retain information to be displayed using the printed dynamic display. Such information can comprise, for example, text, non-textual graphic content (including both real and virtual images), animated content, and/or illumination instructions (regarding, for example, when and how to highlight certain elements of particular displayed content). This information can be fixed in substance and/or form or can be partially or fully changeable and hence customizable. As will be shown below in more detail, such information can be partially or fully stored within this memory through use of an information entry user interface.

If desired, this process 100 will also optionally further comprise integrally combining 104 this paperstock card with one or more sensors that also operably couple to the printed display control circuit. This sensor (or sensors) can respond to any of a wide variety of stimuli including, but not limited to, light, temperature, movement, sound (including specific sounds such as a handclap, a ringtone, or even a specific individual's voice print), pressure, a biometric of choice (such as, for example, an asperity pattern of interest such as a particular person's fingerprint(s)), and so forth. So configured and arranged, the printed display control circuit can dynamically modify operation of the printed dynamic display as a function, at least in part, of information as provided by this sensor(s). As but one simple example in this regard, the display can be automatically activated when the sensor detects at least a minimal level of light (hence suggesting, for example, that a greeting card bearing a particular dynamically displayed greeting has been opened by a recipient).

If desired, this process will further optionally comprise integrally combining 105 this paperstock card with one or more audio transducers (such as, but not limited to, speakers (and their corresponding amplifiers), buzzers, and other noise-sourcing objects of choice) that are again operably responsive to the printed display control circuit (either directly or indirectly). So configured, for example, synchronized or unsynchronized audio content can be provided in conjunction with presentation of dynamic visual content via the printed dynamic display. To illustrate, for example, while the printed dynamic display provides video images of a particular person speaking, the audio transducer can provide a synchronized audio portion that accompanies that video. If desired, the aforementioned memory can further serve to store such audio content for selective playback by the audio transducer. In the alternative, the audio transducer may itself store and retain its audio content.

These optional components can comprise discrete elements that are coupled as described or can also comprise printed component that are integrally combined with the paperstock card.

If desired, this process 100 will further accommodate storing 106 at least partially customized information that is to be displayed in the aforementioned memory. This can be accomplished in a factory setting or in a context that is closer to the purchaser of such a product. Such information can be entered using an information entry user interface of choice (including a keypad, a cursor movement device, a microphone, and so forth). This information entry user interface can be partially or fully integral to the paperstock card or can, if desired, be fully remote from the paperstock card. In the case of a remote-style architecture, the interface itself may comprise a wireless user interface or a non-wireless user interface as desired.

By one approach an opportunity to effect such a partial or full customization of the content to be displayed on the printed dynamic display can comprise a programming opportunity that is offered proximal to a point-of-sale opportunity. For example, a corresponding information input user interface can be located in the greeting card section of a retail establishment such as a greeting card store, a supermarket, a drugstore, and so forth. This opportunity might further comprise, for example, a kiosk or the like that contains a store of the aforementioned paperstock cards. So configured, customization content can be received from a purchaser and then used to program one of the paperstock cards accordingly. The programmed paperstock card can then be dispensed to the purchaser to complete the sales event.

By one approach the purchaser can pay for their programmed paperstock card via the kiosk (or other platform of choice). It would also be possible, of course, to facilitate such a payment through the retail sales transaction platforms and processes used by the retail facility to complete other such transactions.

When the paperstock card includes a sensor as described above, these teachings will then further optionally accommodate then dynamically modifying 107 operation of the printed dynamic display as a function, at least in part, of information as provided by the sensor. This can comprise activating (or deactivating) the display as a function of sensor input. This can also comprise, for example, selecting particular content from a plurality of available content options as a function of sensor input. Other possibilities exist as well in this regard.

Those skilled in the art will appreciate that the above-described processes are readily enabled using any of a wide variety of available technologies and methodologies. Referring now to FIG. 2, an illustrative approach to a representative platform 200 in this regard will now be provided.

In this illustrative example, a paperstock card 201 of choice is integrally combined with a printed display control circuit 202, a printed dynamic display 203, and a printed power source 204. These components are operably coupled as appropriate to permit the printed display control circuit 202 to control the operation of the printed dynamic display 203 while both of the above receive operating power from the printed power source 204. (Those skilled in the art will recognize that multiple such components can be provided in combination with a given paperstock card 201. For example, a single paperstock card 201 can be provided with a plurality of printed display control circuits that independently couple to corresponding printed dynamic displays and printed power sources. As another example, a single printed display control circuit could couple to a plurality of discrete printed dynamic displays. Only one of each of these components is shown in FIG. 2 for the sake of clarity and simplicity.)

The printed display control circuit can comprise a partially or fully programmable circuit if desired. Numerous architectural choices are available in this regard and other options will no doubt become available in the future.

Similarly, numerous options are available as concerns the printed dynamic display. Some examples in this regard would include, but are certainly not limited to, an organic light emitting diode-based display, an electrophoretic-based display, an electrochromic-based display, an electroluminescent ink-based display, a cholesteric display, and a polymer dispersed liquid crystal display, to note but a few. A particular selection in this regard can be based as desired upon such things as cost, durability, resolution, operating speed, color, and the like.

As noted above, such a paperstock card 201 can optionally further comprise an integral memory 205 (which again may comprise a printed component if desired) that operably couples to the printed display control circuit 202 and that serves to contain, in whole or in part, fully or partially customized information (such as that described above) to be displayed using the printed dynamic display 203. By one approach, an information entry user interface 206 that also comprises an integral part of the paperstock card 201 (via, for example, use of printing techniques to combine the information entry user interface 206 with the paperstock card 201) can serve to facilitate the entry of such information into the memory 205. Such an information entry user interface 206 could comprise, for example, a keypad by which a user can input alphanumeric content and/or can indicate a selection of particular candidate display elements.

By another approach (employed either alone or in combination with the above-described integral information entry user interface 207) a remote information entry user interface 207 can be provided. As used herein, the term remote will be understood to refer to a component that is not integral to the paperstock card 201. This remote information entry user interface 207 can again utilize an interface modality of choice (such as an alphanumeric character entry system such as a keypad, a cursor control device, a voice recognition capability, and so forth). The remote information entry user interface 207 can be permanently coupled to the paperstock card 201 if desired. For many application settings, however, it may be useful to configure the remote information entry user interface 207 to only couple temporarily as required to the paperstock card 201 in order to effectuate desired programming of the display capabilities of the apparatus 200. By one approach, this remote information entry user interface 207 can couple as shown via a wireless interface of choice (such as, but not limited to, a Bluetooth wireless interface or other relatively low power, short range wireless link) and/or via a non-wireless interface of choice.

As noted above, one or more sensors 208 can be provided to sense any of a variety of external influences and conditions. These sensors 208 can comprise discrete elements that are combined with the paperstock card 201 (using, for example, an adhesive of choice, printing techniques as are employed for other components as are described herein, and so forth). So configured, and by operably coupling the sensor 208 to the printed display control circuit 202, operation of the printed dynamic display can be dynamically modified as a function, at least in part, of information provided by the sensor 208.

Also as noted above, an audio transducer 209 can also be provided. Such a component can also couple to the printed display control circuit 202 when appropriate (for example, when configuring the apparatus 200 to provide an audio component that is synchronized with respect to the displayed video content). Or, if desired, this audio transducer 209 can comprise an independent element that responds, for example, to another control circuit (not shown), to a corresponding sensor, and so forth. Though only a single audio transducer 209 is shown for the sake of clarity, those skilled in the art will recognize and understand that a plurality of such transducers can be provided if desired.

Those skilled in the art will recognize and understand that such an apparatus 200 may be comprised of a plurality of physically distinct elements as is suggested by the illustration shown in FIG. 2. It is also possible, however, to view this illustration as comprising a logical view, in which case one or more of these elements can be enabled and realized via a shared platform. It will also be understood that such a shared platform may comprise a wholly or at least partially programmable platform as are known in the art. It will also be understood that those supplemental components that require electricity can receive such power by coupling to the above-described printed power source 204 and/or to such other available power source as may be provided.

By these teachings, a wide variety of paperstock cards (of various desired sizes, shapes, configurations, and colors) can be readily and economically provided with a customizable dynamic display capability. This capability, in turn, can facilitate a partial or completely customizable display opportunity. Those skilled in the art will appreciate that these teachings will readily permit the provision of this opportunity at or near a point-of-sale opportunity. As the above-described customization can be readily carried out in a relatively rapid manner, a consumer can receive their customized product within moments of entering their customization content and parameters. These teachings therefore constitute a highly leverageable and scalable construct to facilitate meeting the particular needs and requirements of a wide variety of users.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, a polymer material, such as plastic, can serve in place of the aforementioned paperstock card. Such a material may be particularly suitable, for example, when performance requirements are particularly high.

We claim:

1. A method comprising:
providing a paperstock card;
integrally combining the paperstock card with:
a printed dynamic display;
a printed display control circuit that operably couples to the printed dynamic display;
a printed power source operably coupled to the printed dynamic display and the printed display control circuit.

2. The method of claim 1 wherein the paperstock card comprises at least one of:
a greeting card;
a postcard.

3. The method of claim 1 wherein the printed dynamic display comprises at least one of:
an organic light emitting diode-based display;
an electrophoretic-based display;
an electrochromic-based display;
an electroluminescent ink-based display;
a cholesteric display;
a polymer dispersed liquid crystal display.

4. The method of claim 1 further comprising:
integrally combining the paperstock card with a memory that operably couples to the printed display control circuit;
storing in the memory at least partially customized information to be displayed using the printed dynamic display.

5. The method of claim 4 further comprising entering the at least partially customized information in the memory using at least one of:
an information entry user interface that is integral to the paperstock card;
an information entry user interface that is remote from the paperstock card.

6. The method of claim 5 wherein the information entry user interface that is remote from the paperstock card comprises at least one of:
a wireless user interface;
a non-wireless user interface.

7. The method of claim 4 wherein the at least partially customized information comprises at least one of:
text;
non-textual graphic content;
animated content;
illumination instructions.

8. The method of claim 1 further comprising:
integrally combining the paperstock card with a sensor that operably couples to the printed display control circuit;
dynamically modifying operation of the printed dynamic display as a function, at least in part, of information as provided by the sensor.

9. The method of claim 1 further comprising integrally combining the paperstock card with an audio transducer that is operably responsive to the printed display control circuit.

10. An apparatus comprising:
a paperstock card;
a printed dynamic display integrally combined with the paperstock card;
a printed display control circuit that operably couples to the printed dynamic display and that is integrally combined with the paperstock card;
a printed power source operably coupled to the printed dynamic display and the printed display control circuit and that is integrally combined with the paperstock card.

11. The apparatus of claim 10 wherein the paperstock card comprises at least one of:
a greeting card;
a postcard.

12. The apparatus of claim 10 wherein the printed dynamic display comprises at least one of:
an organic light emitting diode-based display;
an electrophoretic-based display;
an electrochromic-based display;
an electroluminescent ink-based display;
a cholesteric display;
a polymer dispersed liquid crystal display.

13. The apparatus of claim 10 further comprising:
a memory that operably couples to the printed display control circuit and that is integrally combined with the paperstock card, wherein the memory has stored therein at least partially customized information to be displayed using the printed dynamic display.

14. The apparatus of claim 13 further comprising at least one of:
an information entry user interface that is integral to the paperstock card;
an interface to an information entry user interface that is remote from the paperstock card.

15. The apparatus of claim 14 wherein the interface comprises at least one of:
a wireless interface;
a non-wireless interface.

16. The apparatus of claim 13 wherein the at least partially customized information comprises at least one of:
text;
non-textual graphic content;
animated content;
illumination instructions.

17. The apparatus of claim 10 further comprising:
a sensor that operably couples to the printed display control circuit and that is integrally combined with the paperstock card;
and wherein the printed display control circuit is configured and arranged to dynamically modify operation of the printed dynamic display as a function, at least in part, of information as provided by the sensor.

18. The apparatus of claim 10 further comprising:
an audio transducer that is operably responsive to the printed display control circuit and that is integrally combined with the paperstock card.

19. A method of facilitating provision of an at least partially customized paperstock card proximal a point-of-sale opportunity, comprising:
proximal to a retail point-of-sale opportunity:
providing a paperstock card having integrally formed therewith a printed dynamic display, a printed display control circuit that operably couples to the printed dynamic display, and a printed power source operably coupled to the printed dynamic display and the printed display control circuit;
providing an opportunity to at least partially customize content to be displayed on the printed dynamic display via programming.

20. The method of claim 19 further comprising:
proximal to the retail point-of-sale opportunity:
receiving programming regarding at least partial customization of the content to be displayed on the printed dynamic display;
using the programming to at least partially customize the content to be displayed on the printed dynamic display.
